(19) United States
(12) Patent Application Publication
(10) Pub. No.: US 2013/0332196 A1
(43) Pub. Date: Dec. 12, 2013

(54) Diabetes Monitoring Using Smart Device

(71) Applicant: The Government of the United States As Represented By the Secretary of the Army, Fort Detrick, MD (US)

(72) Inventor: Jordan E. Pinsker, Honolulu, HI (US)

(21) Appl. No.: 13/911,137

(22) Filed: Jun. 6, 2013

Related U.S. Application Data
(60) Provisional application No. 61/656,826, filed on Jun. 7, 2012.

(51) Int. Cl. G06F 19/00

(52) U.S. Cl. CPC G06F 19/3406
USPC 705/3

(57) ABSTRACT

A method for communicating diabetes information to a diabetes care provider includes wirelessly transmitting diabetes readings from at least one diabetes device via a patient's smart device to a diabetes care provider's smart device through a secure server; notifying a diabetes care giver of the transmitted diabetes readings; displaying the transmitted diabetes readings on a smart device of the diabetes care provider; and providing messaging between the patient and the diabetes care provider on the patient's smart device and the diabetes care provider's smart device. The system can also automatically post an aggregate of diabetes readings and messages as a new note on a secure website and/or in a patient's electronic medical record.

This application claims priority of U.S. Ser. No. 61/656,826 filed on Jun. 7, 2012 in the U.S. Patent and Trademark Office, the entirety of which is incorporated by reference herein.

### FIELD OF INVENTION

The present invention is directed to a system and methods for real-time diabetes monitoring, in particular to diabetes monitoring using a smart device and allowing secure communication between a patient and a diabetes care provider.

### BACKGROUND OF INVENTION

Diabetes is a chronic disease that can lead to numerous complications including heart disease, eye disease, kidney disease, and neuropathy. Patients with diabetes may require multiple daily injections of insulin and frequent dose changes. In addition, they are constantly adjusting their insulin for their diet plan. Therefore, rapid and timely telehealth review of blood sugar logs to help patients change insulin doses is appealing. However, studies show that even with significant improvement in patient contacts with providers, there is no improvement in metabolic control, as measured by Alc and hypoglycemic (low blood sugar) and hyperglycemic (high blood sugar) episodes.

Participants in previous diabetes telemedicine intervention studies have reported 1) a need to make interaction between patients and clinicians easier, and 2) a need to provide more diet and nutritional educational material for different groups of patients. These themes were repeated in analysis of the highly publicized, randomized controlled Diabetes-STAR trial, which failed to show improvements in self-care behaviors in over 300 diabetic patients after using a customized website for patients to review their labs and records.

Given the high (and rising) incidence of diabetes in the world, improvements in diabetes outcomes are critical. Improved diabetes monitoring has the potential to save billions of dollars in healthcare expenditures due to the myriad of diabetes complications.

### SUMMARY OF INVENTION

According to an aspect of the present invention, a method for communicating diabetes information to a diabetes care provider is provided comprising wirelessly transmitting diabetes readings from at least one diabetes device via a patient's smart device to a secure server; notifying a diabetes care giver of the transmitted diabetes readings; displaying the transmitted diabetes readings on a smart device of the diabetes care provider; and providing messaging between the patient and the diabetes care provider on the patient's smart device and the diabetes care provider's smart device.

According to another aspect of the present invention, a computer implemented method for communicating diabetes information to a diabetes care provider is provided comprising wirelessly receiving diabetes readings transmitted from at least one diabetes device via a patient's smart device; storing the transmitted diabetes readings on a secure server, said server being connected to a plurality of computers via a network; and aggregating the transmitted diabetes readings and messages between the patient and the diabetes care giver.

According to yet another aspect of the present invention, a computer program product for communicating diabetes information to a care provider is provided comprising a non-transitory computer readable storage medium; first program instructions to wirelessly receive transmit diabetes readings from at least one diabetes device via a patient's smart device to a secure server; second program instructions to notify a diabetes care giver of the transmitted diabetes readings; third program instructions to display the transmitted diabetes readings on a smart device of the diabetes care provider; and fourth program instructions to provide messaging between the patient and the diabetes care provider on the patient's smart device and the diabetes care provider's smart device. At least one of the first, second, third, and fourth program instructions are stored on the non-transitory computer readable storage medium.

According to still another aspect of the present invention, a system for communicating diabetes information to a diabetes care provider comprises at least one diabetes device in wireless communication with a first smart device, the first smart device in wireless communication with a secure server, the first smart device receiving diabetes readings from the at least one diabetes device and transmitting the diabetes readings to the secure server; and a second smart device in wireless communication with the secure server for receiving and displaying the diabetes reading in a graphical user interface.

It is an advantage of the present invention to allow physicians to view diabetes information, such as blood sugar logs, with minimal patient intervention required, therefore more effectively monitoring patients and delivering care.

It is another advantage of the present invention to provide patients with timely access to review educational material as they encounter new health issues or problems associated with diabetes.

It is yet another advantage of the present invention that it may be used in areas or countries that have access to Internet technology through smart devices, but otherwise have limited telecommunication resources.

Given the following enabling description of the drawings, the system and methods of the present invention should become evident to a person of ordinary skill in the art.

### BRIEF DESCRIPTION OF THE DRAWINGS

FIG. 1 is a schematic diagram of a system according to an embodiment of the present invention for the transmission of diabetes readings/data over the internet to a secure server.

FIG. 2 is an illustration of graphical user interface of a smart device showing secure communication between a physician and diabetes patient according to an embodiment of the present invention.

FIG. 3 is a flowchart showing a method according to an embodiment of the present invention.

FIG. 4 illustrates a computer program product and computer implementation according to an embodiment of the present invention.

### DETAILED DESCRIPTION OF INVENTION

The present invention is directed to a system and methods for real-time or substantially real-time diabetes monitoring via a smart device and for allowing secure communications between a patient and a diabetes care provider.

In this detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

### A. Real-Time Transmission of Diabetes Readings/Data Via Smart Device

According to the present invention, a smart device (e.g., smartphone, tablet computer, personal digital assistant, wearable digital devices such as a wrist, arm or eyewear devices) having wireless access to the Internet is provided with a software application. Through the software application (or “app”), the smart device is in wireless communication with at least one diabetes device, including, but not limited to, a glucometer, insulin pump, continuous glucose monitoring system (CGMS), implantable monitoring device, wristwatch device, or other wearable monitor, or the like. In specific embodiments, the smart device and at least one diabetes device may be enabled with Wi-Fi, Bluetooth, RF radio, infrared, or any other wireless technology.

According to the present invention, the smart device collects readings from the at least one diabetes device and transmits the results in real-time or near real-time over the internet to a server. Such readings may include, but are not limited to, blood sugar readings (e.g., logs), insulin pump settings, insulin treatment doses, CGMS readings, other insulin treatment data, or any combination thereof. The readings may be encrypted for transmission to the server. In specific embodiments, the server may be a secure server, for example a Health Insurance Portability and Accountability Act (HIPAA) compliant, secure server.

In specific embodiments, the smart device may continuously poll the at least one diabetes device or may periodically poll the at least one diabetes device for readings at a predetermined time (e.g., hourly, daily, weekly) or whenever internet access is or becomes available. No patient interaction is required in this mode. The wearer of the smart device can also manually prompt the device to poll the aforementioned diabetes devices to obtain new data.

The readings may be displayed on a graphical user interface of the patient's smart device before and/or after the readings are transmitted to the server. In specific embodiments, the readings may be displayed, for example, as a table, pie chart, or summary graph.

According to an embodiment of the present invention, the transmitted diabetes readings are posted from the secure server to an administrative version of the app (discussed below) for review. The diabetes care provider's smart device may display the patient's data in the same display formats described above and may be synchronized with the patient's device via the secure server. In this manner, the readings that appear on both the patient's and diabetes care provider's devices show the same synchronized data and allow for further discussion, thereby obviating the need to post the data to a website or other intermediate device for viewing.

However, in specific embodiments, the system has the capability to and may also post the transmitted diabetes readings from the secure server to a secure website that is accessible by plurality of computers via a network. The network may comprise at least one of a wireless network, the internet, the World Wide Web, an intranet network, local area network, or wide area network. In specific embodiments, the secure website may be the Pediatric Diabetes Education Portal (PDEP) website of the Tripler Army Medical Center (TAMC) in Honolulu, Hi. See Pinsker et al., A Pilot Project for Improving Paediatric Diabetes Outcomes using a Website: the Pediatric Diabetes Education Portal, Journal of Telemedicine and Telecare, 2011, 226-30, vol. 17, no. 5 and Recupero, et al., Emerging Technology in Diabetes Care: The Real-Time Diabetes Monitoring System, Military Medicine, 2013, 218-21, vol. 178, the entireties of which are incorporated herein by reference.

According to an embodiment of the present invention, a diabetes care provider may be notified (e.g., via e-mail, phone, text, smart phone banners or alerts, etc.) that readings from a patient's at least one diabetes device have been transmitted. The diabetes care provider may access the readings via an administrative version of the app (discussed below) that displays the transmitted readings on his or her smart device, and/or via a secure website. In specific embodiments, the readings may be displayed, for example, as a table, pie chart, or summary graph.

In specific embodiments, when diabetes readings are received by the server that are above at least one predetermined threshold for a particular patient, the system of the present invention may immediately communicate a warning message to the patient (e.g., “Have you taken your insulin?” or “Are you having low blood sugar?”) prior to, or contemporaneously with, notifying the patient's diabetes care provider. The at least one predetermined threshold may be set by the diabetes care provider and, in embodiments, may be deactivated if a patient becomes capable of dealing with these issues on his or her own.

### B. Secure Communication or Chat Module

According to the system and methods of the present invention, a patient and diabetes care provider may communicate in real-time, as opposed to waiting for an office or clinic visit, via the patient's smart device. Thus, the app on the patient's smart device and the administrative app on the diabetes care provider's smart device may have a secure communication or chat module, thereby providing for two-way communications or messaging. In specific embodiments, the communications may use a smart device's data plan and communicate through a server (e.g., a secure server) to which the transmitted readings/data are sent.

The diabetes care provider may review and interpret the transmitted readings from a patient's at least one diabetes device and then send a message to the patient. In specific embodiments, the message may include, but is not limited to, at least one of discussion of the readings, recommendations for patient action, or reference to educational materials (e.g., accessible via a web link in the message or posted on a related secure website). Alternatively, or in addition thereto, the educational materials may be sent via e-mail to the patient's smart device. The patient may respond to the diabetes care provider with comments or questions, thereby providing for an ongoing dialogue. The timely access to the diabetes care provider and the prompts to review educational material are important to educate patients as they encounter new health issues or problems related to diabetes.

The system and methods of the present invention may provide notification controls that allow not only for real-time communication between a patient and diabetes care provider, but also asynchronous communication, as not every diabetes reading or patient question can or should be immediately answered.

### C. Graphical User Interface of Smart Device

As noted above, an administrative version of the app may be provided to a diabetes care provider for installation on his or her smart device. In specific embodiments, the administrative version of the app may allow a diabetes care provider to switch between two or more patients, for example via a pop-up menu. Thus, the administrative version of the app for diabetes care providers allows switching between different patients and, in embodiments, may allow for assigning patients to different providers within a clinic or hospital.

The administrative app may also automatically notify a diabetes care provider (e.g., via e-mail, phone, text, smart phone banners or alerts, etc.) in real-time that readings from a patient's at least one diabetes device have been transmitted.

In embodiments, the patient version of the app allows a patient to only see only his or her own diabetes readings and communications, for example, in different tabs provided by the app. The patient app may also allow for multiple family members to view the same account data, depending on administrative controls set up by the patient.

### D. Notes in Electronic Medical Record and Billing Module

In an embodiment of the present invention, the administrative version of the app may aggregate 1) any part, or all, of a secure communication between a patient and a diabetes care provider and 2) transmitted readings for a given time period (e.g., daily, weekly, etc.). The aggregated data may be automatically sent, or may be manually sent by the diabetes care provider, to a patient's electronic medical record, for example, at a diabetes clinic or hospital. The aggregated data may be in the form of a new note and, in specific embodiments, may use the Health Level 7 (HL7) standard format or other similar standardized and compatible formats.

For example, a patient may ask for renewal of medicines via the secure communications module and a diabetes care provider may communicate back confirming that the medicines will be ordered. The conversation may appear as a new note in the patient's electronic medical record, to which physicians or diabetes care providers can add orders, write more notes, and sign and send for billing.

In specific embodiments, the administrative version of the app may have a secure billing module for generating billing codes. The billing module may comprise Current Procedural Terminology (CPT) codes for analysis of diabetes information transmitted to the diabetes care provider or physician.

For example, a diabetes care provider or physician may can analyze transmitted blood sugar logs and post a recommended change to the patient's diabetes plan. The secure billing module may generate Relative Value Units (RVU's) using CPT Code 99091 (Collection and interpretation of physiological data digitally stored and/or transmitted by the patient and/or caregiver to the physician or other qualified health care professional) or similar codes as necessary for updated billing requirements.

### E. Example System

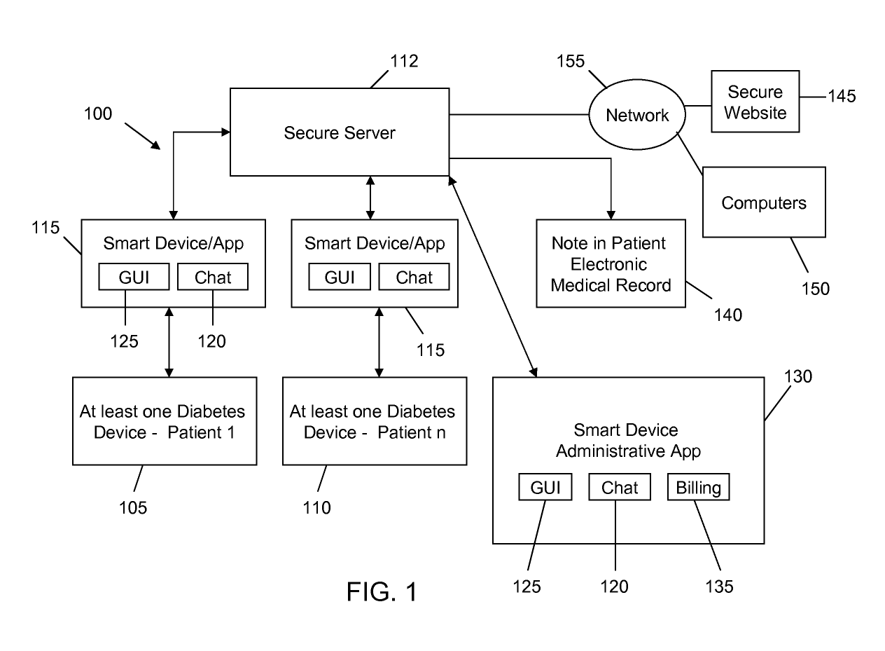

FIG. 1 is a schematic diagram of a system 100 according to an example embodiment of the present invention. The system comprises at least one diabetes device for a patient (patient 1) 105, but may also include diabetes devices for a plurality of patients n, 110. Readings from the at least one diabetes device are transmitted wirelessly to a secure server 112 via patients' respective smart devices, 115. The smart devices each have an app for receiving, transmitting, and displaying the readings and which also provides a secure messaging or chat module 120 to display messages between a patient and a diabetes care provider in a graphical user interface 125.

A smart device 130 of a diabetes care provider may also be in wireless communication with the secure server 112. The smart device 130 of the diabetes care provider may have an administrative version of the app, which not only provides a secure messaging or chat module 120 for displaying messages in a graphical user interface 125, but also provides a billing module 135.

The system 100 allows for the aggregation of diabetes readings and chat between a patient and diabetes care provider for creating of a note in a patient's electronic medical record 140 at a clinic or hospital.

The diabetes readings that have been transmitted to the secure server 112 may be posted from the secure server to a secure website 145 that is accessible by plurality of computers 150 via a network 155.

### F. Example Graphical User Interface on Smart Device

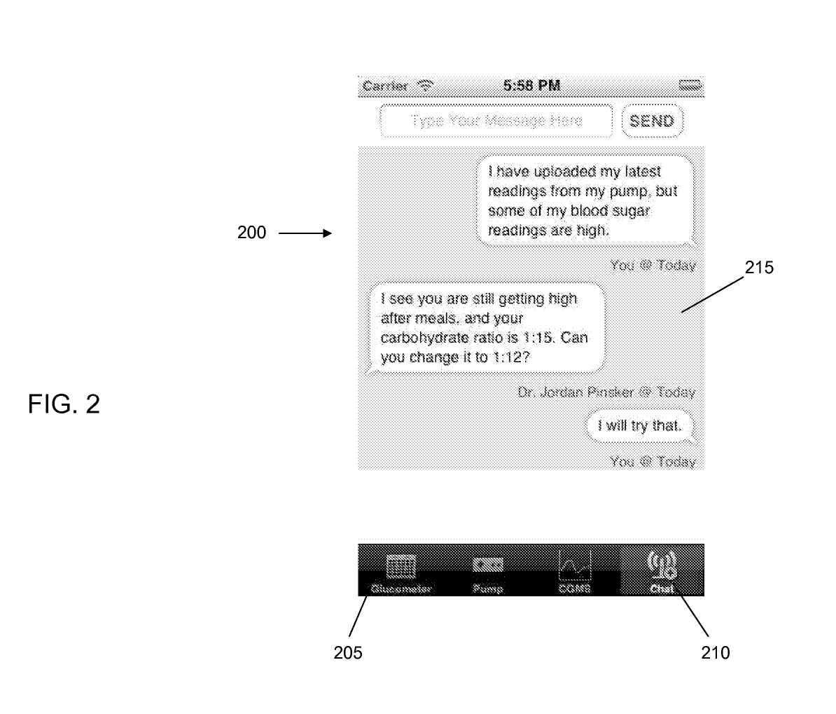

FIG. 2 is an illustration of a graphical user interface (GUI) 200 of a smart device according to an example embodiment of the present invention. The GUI is of an administrative version of the app on a diabetes care provider's smart device. The GUI has icons 205 that allow a diabetes care provider to see transmitted readings from a plurality of diabetes devices. The GUI has an icon 210 allowing for access to secure messaging between the diabetes care provider and a patient, thereby providing for a dialogue 215 in the GUI as shown.

### G. Example Method

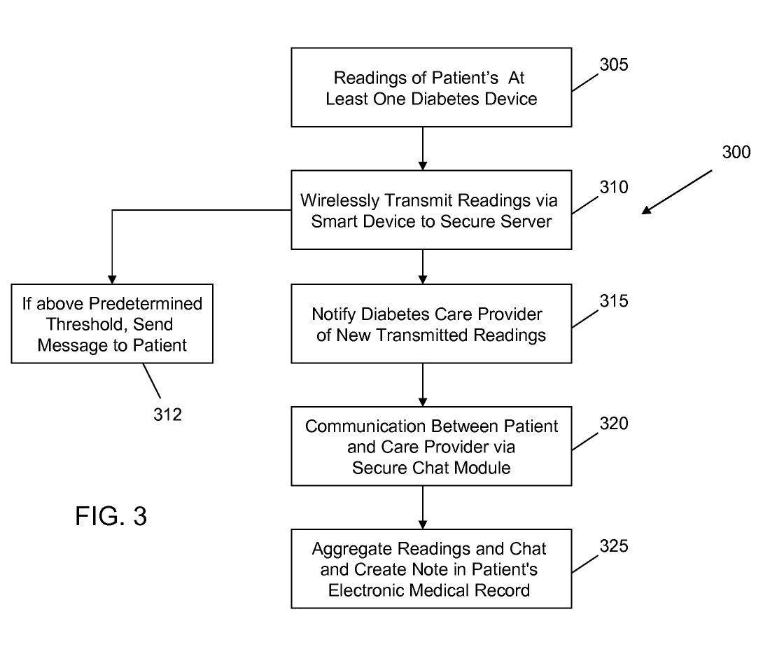

FIG. 3 is a flowchart showing a method 300 according to an example embodiment of the present invention. Diabetes readings from a patient's at least one diabetes device 305 are transmitted wirelessly via the patient's smart device to a secure server 310. If the transmitted readings are above a preset or predetermined threshold, a message is automatically sent to the patient's smart device 312.

A diabetes care provider is notified of the new transmitted readings 315. The patient and diabetes care provider have a communication via a secure communication or chat module on the patient's and diabetes care provider's respective smart devices 320. The transmitted readings and messages/chat between the patient and diabetes care provider are aggregated and a new note is created in the patient's electronic medical record 325.

Although the present invention has been discussed with respect to diabetes, its usefulness may be extrapolated for real-time monitoring of blood pressure for high risk patients or for use with INR monitors, ECG, Peak Flow, CPAP, spirometers, oxygen saturation measurements.

### H. Computer Implementation

As will be appreciated by one skilled in the art based on this disclosure, aspects of the present invention may be embodied as a system, method or computer program product. Accordingly, aspects of the present invention may take the form of an entirely hardware embodiment, a processor operating with software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this disclosure, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer program code for carrying out operations for aspects of the present invention may be written in any combination of one or more programming languages, including an object oriented programming language such as Java, Smalltalk, C++, C#, Transact-SQL, XML, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified.

These computer program instructions may also be stored in a computer readable medium that can direct a computer, other programmable data processing apparatus, or other devices to function in a particular manner, such that the instructions stored in the computer readable medium produce an article of manufacture including instructions which implement the functions/acts specified.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified.

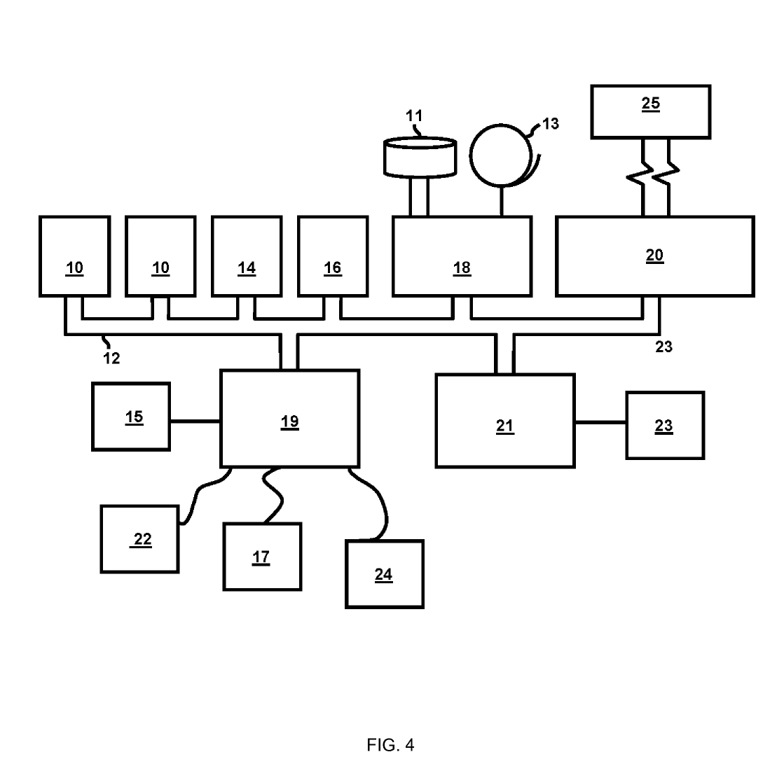

Referring now to FIG. 4, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

As used herein, “in communication” includes physical and wireless connections that are indirect through one or more additional components (or over a network) or directly between the two components described as being in communication.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

As used above “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

Those skilled in the art will appreciate that various adaptations and modifications of the example and alternative embodiments described above can be configured without departing from the scope and spirit of the invention. Therefore, it is to be understood that, within the scope of the appended claims, the invention may be practiced other than as specifically described herein.

What is claimed is:

1. A method for communicating diabetes information to a diabetes care provider, comprising:
wirelessly transmitting diabetes readings from at least one diabetes device via a patient's smart device to a secure server;
notifying a diabetes care giver of the transmitted diabetes readings;
displaying the transmitted diabetes readings on a smart device of the diabetes care provider; and
providing messaging between the patient and the diabetes care provider on the patient's smart device and the diabetes care provider's smart device.

2. A method according to claim 1, further comprising displaying the transmitted diabetes readings on the smart device of the patient.

3. A method according to claim 1, wherein the at least one diabetes device is selected from the group consisting of a glucometer, insulin pump, continuous glucose monitoring system, implantable monitoring device, wristwatch device, wearable monitor, and combinations thereof.

4. A method according to claim 1, wherein the at least one diabetes device comprises an implantable monitoring device or wearable monitor.

5. A method according to claim 1, wherein the at least one diabetes device comprises a wrist, arm, or eyewear device.

6. A method according to claim 1, wherein the at least one diabetes device comprises a plurality of diabetes devices.

7. A method according to claim 1, wherein the smart device comprises a smart phone or tablet computer.

8. A method according to claim 1, wherein the diabetes readings comprises at least one of sugar readings, insulin pump settings, insulin treatment doses, continuous glucose monitoring system readings, or insulin treatment data.

9. A method according to claim 1, further comprising automatically sending a message to the patient's smart device if the transmitted diabetes readings are above a predetermined threshold.

10. A method according to claim 1, further comprising sending the patient educational information to the patient's smart device based on the transmitted diabetes readings.

11. A method according to claim 1, comprising conducting two-way messaging in real-time between the patient and the diabetes care giver regarding the transmitted diabetes readings.

12. A method according to claim 11, further comprising:
aggregating the transmitted diabetes readings and messages between the patient and the diabetes care giver; and
creating a new note in the patient's electronic record comprising the aggregated diabetes readings and messages.

13. A method according to claim 12, wherein the note comprises a patient request for renewal of medicine.

14. A method according to claim 1, further comprising displaying the transmitted diabetes readings of a plurality of patients on a smart device of the diabetes care giver.

15. A method according to claim 1, further comprising displaying the transmitted diabetes readings of a plurality of diabetes devices on a smart device of the diabetes care giver.

16. A method according to claim 1, wherein the secure server comprises a Health Insurance Portability and Accountability Act compliant, secure server.

17. A method according to claim 1, comprising polling the at least one diabetes device for new diabetes readings at a predetermined time without patient interaction.

18. A method according to claim 1, further comprising posting the transmitted diabetes readings to a secure website accessible by a plurality of computers over a network.

19. A method according to claim 1, further comprising generating billing codes on the diabetes care provider's smart device based on analysis of the transmitted diabetes readings.

20. A computer implemented method for communicating diabetes information to a diabetes care provider, comprising:
wirelessly receiving diabetes readings transmitted from at least one diabetes device via a patient's smart device;
storing the transmitted diabetes readings on a secure server, said server being connected to a plurality of computers via a network; and
aggregating the transmitted diabetes readings and messages between the patient and the diabetes care giver.

21. A computer program product for communicating diabetes information to a care provider, comprising:
a non-transitory computer readable storage medium;
first program instructions to wirelessly receive transmit diabetes readings from at least one diabetes device via a patient's smart device to a secure server;
second program instructions to notify a diabetes care giver of the transmitted diabetes readings;
third program instructions to display the transmitted diabetes readings on a smart device of the diabetes care provider; and
fourth program instructions to provide messaging between the patient and the diabetes care provider on the patient's smart device and the diabetes care provider's smart device,
wherein at least one of said first, second, third, and fourth program instructions are stored on said non-transitory computer readable storage medium.
